(19) United States
(12) Patent Application Publication
(10) Pub. No.: US 2017/0145599 A1
(43) Pub. Date: May 25, 2017

(54) METAL-ORGANIC FRAMEWORK COMPOSITES, AND METHODS OF SYNTHESIS THEREOF

(71) Applicant: ARIZONA BOARD OF REGENTS ON BEHALF OF ARIZONA STATE UNIVERSITY, SCOTTSDALE, AZ (US)

(72) Inventors: BIN MU, TEMPE, AZ (US); MITCHELL ARMSTRONG, TEMPE, AZ (US)

(73) Assignee: ARIZONA BOARD OF REGENTS ON BEHALF OF ARIZONA STATE UNIVERSITY, SCOTTSDALE, AZ (US)

(21) Appl. No.: 15/357,681

(22) Filed: Nov. 21, 2016

Related U.S. Application Data
(60) Provisional application No. 62/257,571, filed on Nov. 19, 2015.

(51) Int. Cl. D01F 11/06; D01D 5/00; B29C 47/00; B29C 35/08; D01F 6/20; D06M 13/503

(52) U.S. Cl. CPC D01F 11/06; D01F 6/20; D06M 13/503; B29C 47/0014; B29C 47/0076; B29C 35/0805; B29C 35/0866; D01D 5/003; D06M 2101/26

(57) ABSTRACT

Some embodiments include a method of preparing polymer nanofiber composites using a cross-linkable polymer precursor solvated with a solvent, and forming a nanofiber precursor by mixing with a metal-organic-framework (MOF) crystal material that includes a metal ion coupled to at least one multidentate ligand. Further, the method can include forming a plurality of nanofibers by electro-spinning the nanofiber precursor, where at least a portion of the nanofibers includes a dispersion of the first MOF crystal material. The method can include crosslinking the plurality of nanofibers by irradiating the plurality of nanofibers with UV light, IR light, visible light, gamma radiation, and/or electro-beam radiation. Further, the method can include applying a second MOF crystal material between the cross-linked nanofibers and the first MOF material.

### RELATED APPLICATIONS

This application claims priority to U.S. provisional application Ser. No. 62/257,571, filed on Nov. 19^{th}, 2015, the entire contents of which are incorporated herein by reference.

### BACKGROUND

Metal organic framework (MOF) crystals have been extensively studied for many applications such as sensing, catalysis, separations, and gas storage in part due to their high surface area and tunability. Some MOF materials have low stabilities, and their nanometer to micrometer powder size is sometimes not ideal for specific applications. Zirconium based MOFs (ZrMOF) are becoming more popular due in part to their superior stability relative to MOFs based on other metals. In this regard, ZrMOF, UiO-66 (also called Zr-BDC) is considered the archetypal MOF.

In order to increase the suitability of MOFs to other applications, work has been done to grow MOF crystals on various substrates such as porous stainless steel, metal alloys, and polymeric hollow-tube membranes. Recently, nanofibers have been introduced as a MOF growth platform. In particular, plastic nanofibers are a promising material due to their established use in many fields such as sensing, protective clothing, and separations. Some work has included electrospun MOF impregnated nanofibers, with secondary growth of MOFs on the fibers. However, to synthesize nano-composite MOF/ nanofiber materials with secondary growth of MOF, the nano-composite MOF/ nanofiber materials must be placed in a solvent, and heated above 100° C. for extended periods of time in order to effectively grow the MOF crystals. These conditions are generally too extreme for the nanofibers, and can lead to dissolution or contraction of the nanofibers. Hence, there is a need for a method of producing nano-composite MOF/ nanofiber materials that is less reliant on polymers that require a high thermal stability, high chemical stability, with solubility in specific solvents.

### SUMMARY

Some embodiments include a method of preparing polymer nanofiber composites comprising providing at least one cross-linkable polymer precursor, and at least partially solvating the at least one cross-linkable polymer precursor with at least one solvent. Further, the method can include forming a nanofiber precursor by mixing at least one first metal-organic-framework (MOF) crystal material with the solvated polymer precursor, where the at least one first MOF crystal material comprises at least one metal ion coupled to at least one multidentate ligand. Further, the method can include forming a plurality of nanofibers by electro-spinning at least some portion of the nanofiber precursor, where at least a portion of the nanofibers include a dispersion of the at least one first MOF crystal material. The method can include crosslinking at least a portion of the plurality of nanofibers by irradiating at least a portion of the plurality of nanofibers with UV light, IR light, visible light, gamma radiation, and/or electro-beam radiation. Further, the method can include applying a second MOF crystal material between at least a portion of the cross-linked nanofibers and the at least one first MOF material.

In some embodiments, the second MOF crystal material comprises a composition different from the first MOF crystal material. In further embodiments, the compositions of the first and second MOF crystal materials are substantially the same. In some embodiments, the first MOF crystal material is a product of reaction between ZrCl₄ and terephthalic acid in the presence of dimethylformamide.

In some embodiments, the at least one metal ion comprises Zirconium. In some further embodiments, the at least one cross-linkable polymer precursor comprises poly(vinyl cinnamate). In some embodiments, the specific period of time is between 30 minutes and 3 hours. In some embodiments, the least one second MOF crystal material is formed in-situ.

In some embodiments, the least one second MOF crystal material is formed in-situ using a process comprising exposing at least a portion of the cross-linked nanofibers with the least one first MOF material to a mixture of ZrCl₄ and terephthalic acid in dimethylformamide, and heating in an autoclave to a specific temperature for a specific secondary reaction time.

In some embodiments, the mixture comprises 0.115 g of ZrCl₄ and about 0.083 grams of terephthalic acid in about 35 mL of DMF. In some further embodiments, the specific temperature is between 80° C. and 100° C. In some embodiments, the process further comprises removing the cross-linked nanofibers from the autoclave after heating and allowing the cross-linked nanofibers to cool.

In some embodiments, the process is repeated at least once. In some further embodiments, the polymer precursor includes a secondary photoreactive polymer, prepolymer, blend, or mixtures thereof. In some embodiments, the photoreactive polymer includes at least one of a polyurethane or polyester acrylate.

In some embodiments, the nanofiber composites preparation method comprises forming a nanofiber precursor by mixing at least one metal-organic-framework (MOF) crystal material with at least one polymer precursor and at least one solvent, and forming a plurality of nanofibers by electro-spinning at least some portion of the nanofiber precursor, where the plurality of nanofibers include a dispersion of the at least one first MOF crystal material. Further, the method can include crosslinking at least a portion of the plurality of nanofibers, and forming a second MOF crystal material in-situ on or between at least a portion of the cross-linked nanofibers.

### DESCRIPTION OF THE DRAWINGS

FIG. 1 shows a summary of a metal-organic framework—polymer composites synthesis process in accordance with some embodiments of the invention.

FIG. 2 shows a PVCi crosslinking mechanism in accordance with some embodiments of the invention.

FIG. 3 shows FTIR absorbance for pure PVCi nanofiber irradiation times of 0, 30, 60, and 120 minutes stacked and normalized to each spectra's maximum intensity in accordance with some embodiments of the invention.

FIG. 4 shows normalized and stacked FTIR absorbance spectra of the UiO-66 seeds and UiO-66 impregnated PVCi membranes after crosslinking and at each reported stage of secondary growth at 80° C. in accordance with some embodiments of the invention.

FIG. 5 shows normalized and stacked FTIR absorbance spectra of the UiO-66 seeds and UiO-66 impregnated PVCi membranes after crosslinking and at each reported stage of secondary growth at 100° C. in accordance with some embodiments of the invention.

FIG. 6 shows PXRD patterns comparing the final membranes after each 12 hour growth period at 80° C. and 100° C. compared to a simulated pattern for pure UiO-66 powder in accordance with some embodiments of the invention.

FIG. 7 shows PXRD patterns of membranes after each 12 hour growth period for 80° C. synthesis temperatures normalized to the maximum intensity found from the 3rd growth at 100° C. in accordance with some embodiments of the invention.

FIG. 8 shows PXRD patterns of membranes after each 12 hour growth period for 100° C. in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments include polymers that comprise a homopolymer comprising cross-linkable functional groups. In some further embodiments, the polymer can comprise a copolymer including at least one type of cross-linkable group. In some further embodiments, the polymer can comprise a polymer blend including at least one polymer that includes a cross-linkable group. Some embodiments of the invention include the use of a commercially available polymer, Poly(vinyl cinnamate) (hereinafter PVCi) to produce polymer composites including a metal-organic-framework (hereinafter “MOF”). In some embodiments, a Zirconium-based MOF (hereinafter “ZrMOF”) is used. In some embodiments, the ZrMOF can comprise the group of materials UiO (University of Oslo), including, but not limited to, UiO-66. In some embodiments, the polymer can be cross-linked by exposure to UV light. In some other embodiments, the polymer can be cross-linked by exposure to infra-red light. In some further embodiments, the polymer can be cross-linked by exposure to visible light. In some embodiments, the polymer can be cross-linked by exposure to multiple wavelengths of light including, but not limited to, UV light, IR light, and visible light.

In some embodiments, the PVCi is electrospun. In some embodiments, changes in structure, chemical stability, and thermal stability are induced by ultraviolet light crosslinking of the PVCi. In some embodiments, ZrMOF is grown via solvothermal secondary growth on electrospun mats to form various topologies. Using these methods, in some embodiments, continuous UiO-66 membranes with PVCi scaffolding for structural support can be prepared. In some other embodiments, other MOFs requiring strong solvents and temperatures, as well as any other polymers that can be electrospun and cross-linked can be used.

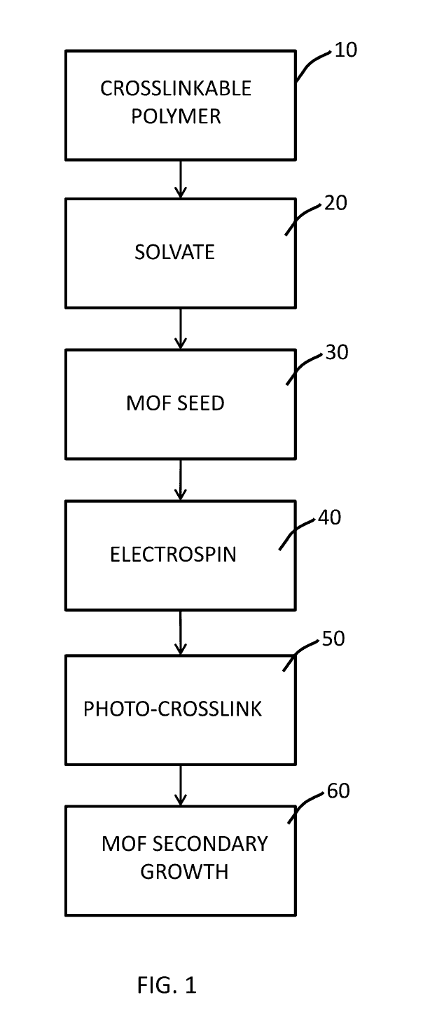

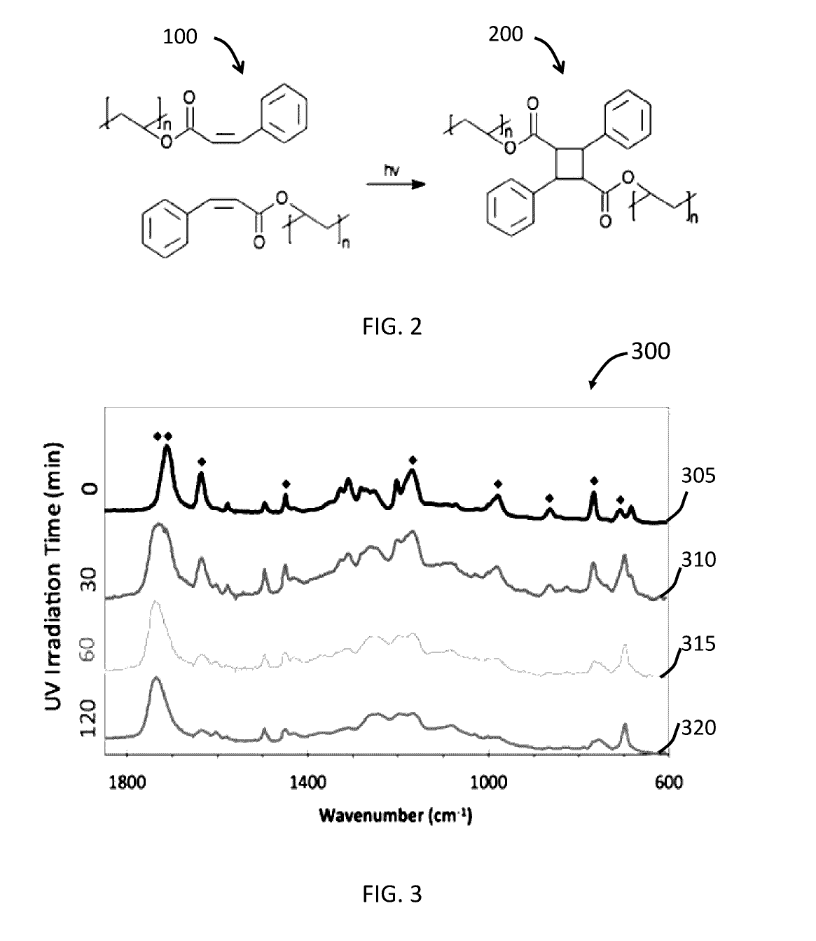

FIG. 1 shows a summary of the metal-organic framework—polymer composites synthesis process described above. In some embodiments of the invention, the process can include providing a cross-linkable polymer (shown as step 10). In some embodiments, the cross-linkable polymer can comprise a photoreactive cross-linkable polymer such as PVCi. PVCi comprises a polyvinyl alcohol backbone that includes cinnamoyl side chains that can be photo-cross-linked using UV irradiation through cycloaddition reactions (see FIG. 2 showing PVCi monomers 100 crosslinking to crosslinked PVCi 200). In some other embodiments, the polymer precursor can comprise a further or secondary photoreactive polymer, prepolymer, blend, or mixtures thereof. For example, in some embodiments, the photoreactive polymer, prepolymer, blend, or mixtures thereof can include at least one photoreactive monomer or oligomer. As one non-limiting example, some embodiments include a photoreactive acrylate such as a polyurethane or polyester acrylate. Further, in some embodiments, the polymer precursor can include a photoinitiator. For example, in some embodiments, a UV sensitive or reactive photoinitiator can be used that is soluble in the polymer precursor or polymer precursor solution.

In some embodiments, the cross-linkable polymer can be solvated using a solvent for the polymer to produce a polymer solution (shown as step 20). For example, in some embodiments, dichloromethane can be used to form a PVCi solution. Following polymer solvation, one or more MOF materials can be added as a MOF seed material (step 30) to form a polymer solution with dispersed MOF seed (hereinafter referred to as “nanofiber precursor”). For example, solvothermal reactions can be carried out in a Teflon® lined autoclave by mixing about 0.357 grams of ZrCl₄ and about 0.254 grams of terephthalic acid in about 21 mL of dimethylformamide (DMF) and about 8.6 mL of acetic acid. The mixture solution can be heated to about 120° C. for about 24 hours, and then cooled to room temperature yielding white colored crystals. The synthesized sample (comprising UiO-66 crystals) can be obtained by filtration, and dried in air for about 24 h before use. In some embodiments, solutions of about 10 wt % PVCi/DCM with about 100 mg of UiO-66 crystals can be prepared and stored in darkness at room temperature until use.

In some embodiments, the nanofiber precursor can be electrospun to produce a plurality of nanofibers (step 40). In some embodiments, PVCi and PVCi with UiO-66 samples can be fed through a metallic needle by a syringe pump (such as one produced by New Era Pump Systems, Inc.) at the rate of about 3 and about 4.2 ml h⁻1, respectively. A voltage of about 22 kV (Gamma High Voltage Research) can be applied between the spinneret and the collector with a distance of about 6 cm at room temperature. The spun-nanofibers mats can be collected and dried at room temperature for about 24 hours. In some embodiments, the nanofiber precursor can be electrospun into a plurality of fibers. In some further embodiments, the nanofiber precursor can be electrospun into a mat. In some other embodiments, the nanofiber precursor can be electrospun into a membrane or any other physical structure.

In some embodiments, the nanofibers can comprise nanofibers with a dispersion or distribution of the MOF materials that can be originally found in the nanofiber precursor. In some embodiments, at least a portion of the MOF materials can be dispersed substantially homogenously through at least a portion of the nanofiber. In some other embodiments, at least a portion of the MOF materials can be substantially unevenly distributed through at least a portion of the nanofiber. In some embodiments, at least some portion of the MOF materials can exist as discrete particles. In other embodiments, at least a portion of the MOF materials can comprise an association or cluster of a plurality of MOF particles within or on the nanofibers. In some embodiments, the MOF materials can comprise a particle or cluster size of between about 1 and about 10 microns. In some other embodiments, at least some portion of the MOF materials can be sub-micron sized. In some other embodiments, at least a portion of the MOF materials can comprise nano-sized particles.

In some embodiments, the nanofibers (either as a plurality of nanofibers, a mat, or a membrane) can be cross-linked (step 50). For example, in some embodiments, the nanofibers can be cross-linked by exposing the electrospun nanofibers to UV irradiation. In some embodiments, the electrospun PVCi mats can be irradiated with ultraviolet (UV) light for about 30, or about 60, and/or about 120 minutes. FIG. 3 shows a graph 300 of FTIR absorbance for pure PVCi nanofiber irradiation times of 0 minutes (spectra 305), 30 minutes (spectra 310), 60 minutes (spectra 315), and 120 minutes (spectra 320) stacked and normalized to each spectra's maximum intensity in accordance with some embodiments of the invention.

In some further embodiments, the PVCi with UiO-66 solution can be UV irradiated for about 3 h. The irradiation of nanofibers can be carried out by a UVM-28 EL Series UV Lamp (UVP, LLC, CA, USA) emitting a light intensity of about 2000 μW/cm² at a wavelength of about 302 nm at room temperature. The mats can be placed under the UV light with a distance of about 4 cm from the lamp head. An initial about 15 minute time period was allotted for the lamp to warm up before exposing to nanofibers. In other embodiments, other wavelengths of UV light, IR light, visible light, gamma radiation, electro-beam radiation, and/or an initiator can be used to cross-link the nanofibers.

Some embodiments include alternatives to solution electrospinning as described. For example, in some embodiments, coaxial electrospinning can be used where multiple solutions and be prepared and co-injected through a tip of a spinneret. In some further embodiments, emulsion electrospinning can be used. For example, in some embodiments, an emulsion of polymer, solvent and MOF can be prepared and electrospun through a tip of a spinneret. In other embodiments. In some other embodiments, melt electrospinning can be used with a polymer including dispersed MOF. For example, in some embodiments, the seed MOF can be introduced into the polymer using solution casting, in-situ reaction, extrusion, blending, or other conventional composite fabrication method, and then subsequently melt-spun to produce polymer nanofiber with dispersed seed MOF.

In some embodiments, the cross-linked nanofibers can be exposed to additional MOF materials to initiate and encourage a secondary growth of MOF within and/or on the nanofibers (step 60). For example, in some embodiments, UiO-66 seeds were synthesized and suspended in solutions of PVCi in DCM. In some embodiments, the seeds can be about 500 nm in diameter. Through the process of electrospinning, MOF and PVCi were passed through the needle resulting in seeds mechanically anchored into the fibers to provide nucleation points for secondary growth. Further, for example, in some embodiments, photo-cross-linked PVCi with UiO-66 mats can be cut to fit inside a 100 mL Teflon lined autoclaves and filled with a solution of about 0.115 g of ZrCl4 and about 0.083 grams of terephthalic acid in about 35 mL of DMF. Samples can be heated at 100° and 80° C. for about 12 hours. The membranes can be collected from the autoclave and allowed to cool. The procedure was repeated three or four times at about 100° C. and about 80° C., respectively. Final membranes can be washed multiple times with DMF to remove any excess UiO-66. In some embodiments, the MOF used in the secondary growth can be the same as the seeded MOF. In other embodiments, the seed MOF and the secondary growth MOF can comprise a different composition.

In some embodiments, to achieve the nearly complete crosslinking desired for the secondary growth of UiO-66, a 3 hour UV irradiation time was carried out to achieve a similar degree of crosslinking as the 2 hour time for pure PVCi nanofibers according to FTIR. It is hypothesized that the longer times required to crosslink MOF impregnated nanofibers relative to pure nanofibers is because of the increased average distance between PVCi functional groups caused by the presence of MOFs impregnated in the fibers, and a smaller amount of available crosslinking sites available because of this spacing.

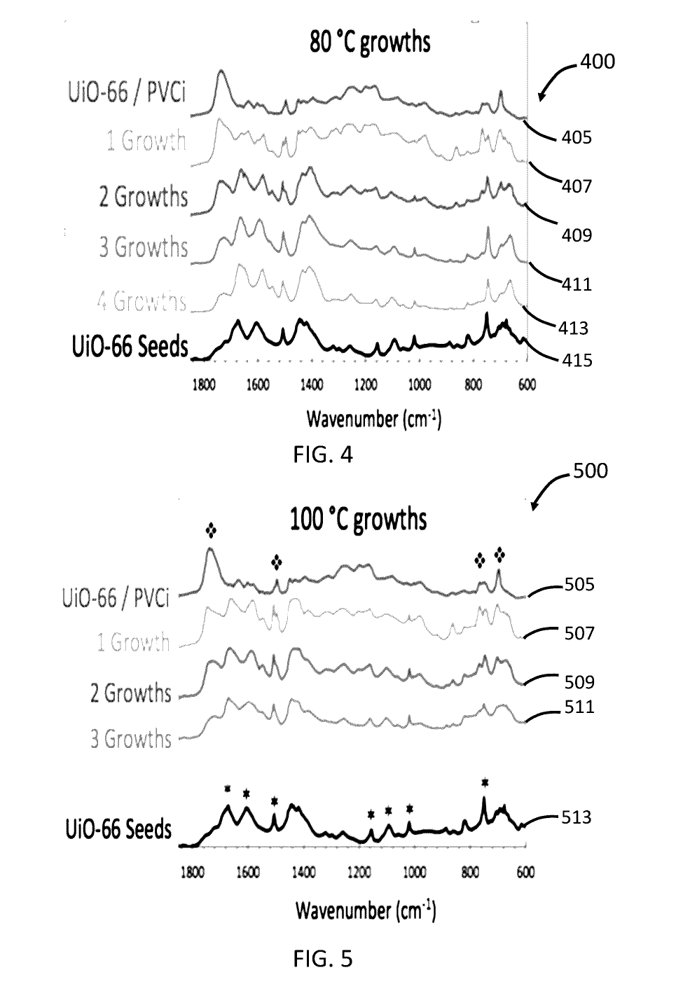

In some embodiments of the invention, after crosslinking, UiO-66 secondary growths were performed at 100° C. and 80° C., and every 12 hours the samples were dried and placed into a fresh growth solution until the final membranes were produced. Samples were analysed at each time step to study the effects of each temperature and each growth. FTIR spectra patterns of each growth were recorded. For example, FIG. 4 shows normalized and stacked FTIR absorbance spectra of the UiO-66 seeds and UiO-66 impregnated PVCi membranes after crosslinking and at each reported stage of secondary growth at 80° C. in accordance with some embodiments of the invention. Further, FIG. 5 shows normalized and stacked FTIR absorbance spectra of the UiO-66 seeds and UiO-66 impregnated PVCi membranes after crosslinking and at each reported stage of secondary growth at 100° C. in accordance with some embodiments of the invention. From the FTIR spectra it can be seen that the peaks representative of the UiO-66 crystal pattern increase with increasing growths. In reference to the FIG. 4, graph 400 shows UiO-66/PVCi with no secondary growth (spectra 405), UiO-66/PVCi with one secondary growth (spectra 407), UiO-66/PVCi with two secondary growths (spectra 409), UiO-66/PVCi with three secondary growths (spectra 411), UiO-66/PVCi with four secondary growth (spectra 413), and UiO-66 seeds (spectra 415). In reference to the FIG. 5, graph 500 shows UiO-66/PVCi with no secondary growth (spectra 505), UiO-66/PVCi with one secondary growth (spectra 507), UiO-66/PVCi with two secondary growths (spectra 509), UiO-66/PVCi with three secondary growths (spectra 511), UiO-66/PVCi with four secondary growth (spectra 513), and UiO-66 seeds (spectra 515). The stability of the PVCi fibers at increased temperature, and prolonged chemical exposure times is reaffirmed by the absence of a doublet or peak shift at 1737 cm⁻¹, which would indicate the breaking of crosslinking bonds. Systematic decreases in representative PVCi peaks across the FTIR spectra occur as well at 1737 cm⁻¹, 1498 cm⁻¹, 754 cm⁻¹, and 608 cm⁻¹, while peaks provided by the UiO-66 seeds steadily become more prominent with growths at 1675 cm⁻¹, 1507 cm⁻¹, 1157 cm⁻¹, 1094 cm⁻¹, 1020 cm⁻¹, and 750 cm⁻¹.

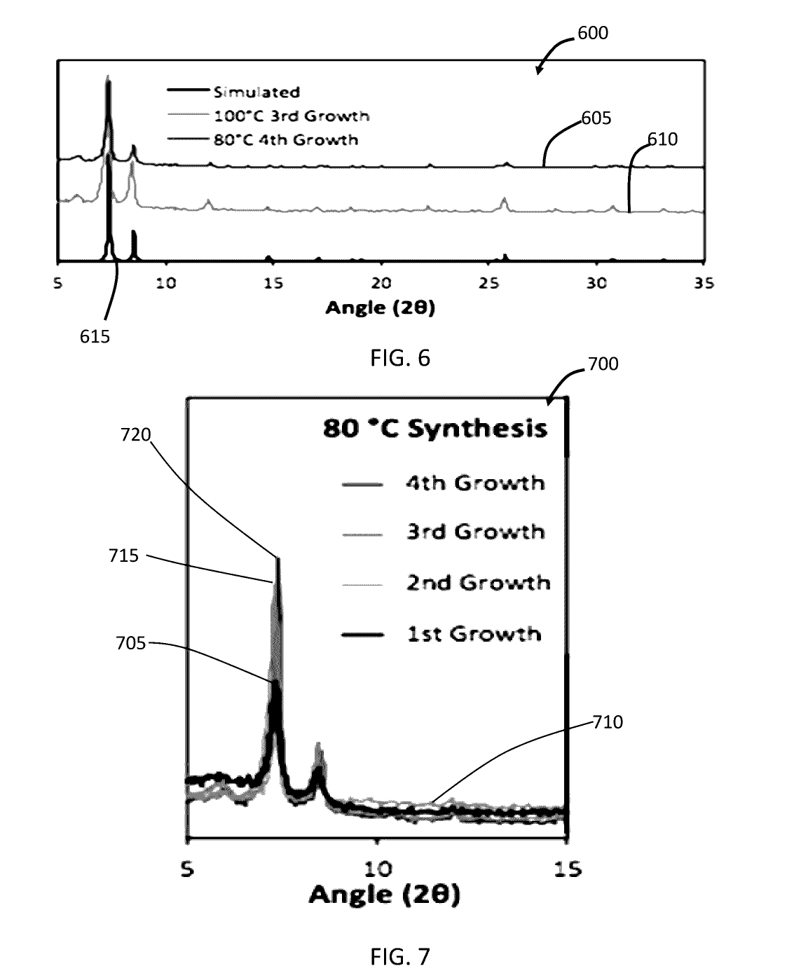

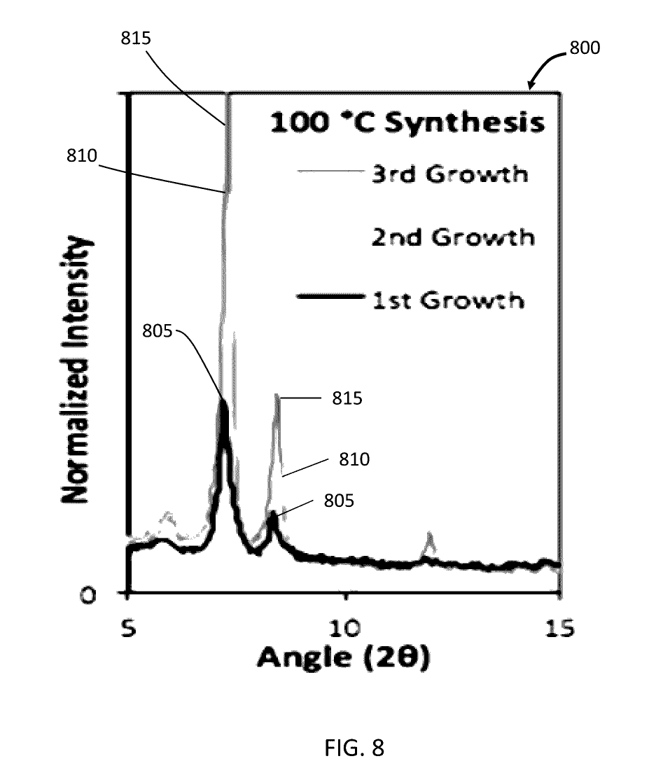

FIGS. 6-8 shows PXRD patterns performed on membranes of each time step to monitor the synthesis of UiO-66 at each interval. For example, FIG. 6 shows PXRD patterns comparing the final membranes after each 12 hour growth period at 80° C. (spectra 605) and 100° C. (spectra 610) compared to a simulated pattern 615 for pure UiO-66 powder in accordance with some embodiments of the invention. Further, FIG. 7 shows a plot 700 of PXRD patterns of membranes after each 12 hour growth period for 80° C. synthesis temperatures normalized to the maximum intensity found from the 3rd growth at 100° C. in accordance with some embodiments of the invention. For example, the plot 700 shows 1^{st} growth spectra 705, 2^{nd} growth spectra 710, third growth spectra 715, and 4^{th} growth spectra 720. Further, FIG. 8 shows a plot 800 of PXRD patterns of membranes after each 12 hour growth period for 100° C. in accordance with some embodiments of the invention. Plot 800 shows 1^{st} growth spectra 805, 2^{nd} growth spectra 810, third growth spectra 815. The intervals each show an increase in crystallinity as the UiO-66 crystals emerge and engulf the PVCi fibers, and the final pattern for each temperature are compared to a simulated PXRD pattern from single crystal XRD data. The peaks from the membranes match the peaks of the simulated pattern with the addition of a peak near 12 2θ, which was also present in the UiO-66 seed crystals.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of preparing polymer nanofiber composites comprising:
providing at least one cross-linkable polymer precursor;
at least partially solvating the at least one cross-linkable polymer precursor with at least one solvent;
forming a nanofiber precursor by mixing at least one first metal-organic-framework (MOF) crystal material with the solvated polymer precursor, the at least one first MOF crystal material comprising at least one metal ion coupled to at least one multidentate ligand;
forming a plurality of nanofibers by electro-spinning at least some portion of the nanofiber precursor, wherein at least a portion of the nanofibers include a dispersion of the at least one first MOF crystal material;
crosslinking at least a portion of the plurality of nanofibers by irradiating at least a portion of the plurality of nanofibers with at least one of UV light, IR light, visible light, gamma radiation, electro-beam radiation; and
introducing a second MOF crystal material between at least a portion of the cross-linked nanofibers and the at least one first MOF material.

2. The method of claim 1, wherein the second MOF crystal material comprises a composition different from the first MOF crystal material.

3. The method of claim 1, wherein the compositions of the first and second MOF crystal materials are substantially the same.

4. The method of claim 1, wherein the first MOF crystal material is a product of reaction between ZrCl₄ and terephthalic acid in the presence of dimethylformamide.

5. The method of claim 1, wherein the at least one metal ion comprises Zirconium.

6. The method of claim 1, wherein the at least one cross-linkable polymer precursor comprises poly(vinyl cinnamate).

7. The method of claim 1, wherein the specific period of time is between 30 minutes and 3 hours.

8. The method of claim 1, wherein the least one second MOF crystal material is formed in-situ.

9. The method of claim 8, wherein the least one second MOF crystal material is formed in-situ using a process comprising exposing at least a portion of the cross-linked nanofibers with the least one first MOF material to a mixture of ZrCl₄ and terephthalic acid in dimethylformamide, and heating in an autoclave to a specific temperature for a specific secondary reaction time.

10. The method of claim 9, wherein the mixture comprises 0.115 g of ZrCl₄ and about 0.083 grams of terephthalic acid in about 35 mL of DMF.

11. The method of claim 9, wherein the specific temperature is between 80° C. and 100° C.

12. The method of claim 9, wherein the process further comprises removing the cross-linked nanofibers from the autoclave after heating and allowing the cross-linked nanofibers to cool.

13. The method of claim 11, wherein the process is repeated at least once.

14. The method of claim 1, wherein the polymer precursor includes a secondary photoreactive polymer, prepolymer, blend, or mixtures thereof.

15. The method of claim 14, wherein the photoreactive polymer includes at least one of a polyurethane or polyester acrylate.

16. A nanofiber composites preparation method comprising:
forming a nanofiber precursor by mixing at least one metal-organic-framework (MOF) crystal material with at least one polymer precursor and at least one solvent;
forming a plurality of nanofibers by electro-spinning at least some portion of the nanofiber precursor, wherein the plurality of nanofibers include a dispersion of the at least one first MOF crystal material;
crosslinking at least a portion of the plurality of nanofibers; and
forming a second MOF crystal material in-situ on or between at least a portion of the cross-linked nanofibers.

17. The method of claim 16, wherein the crosslinking of at least a portion of the plurality of nanofibers is accomplished by irradiating at least at portion of the plurality of nanofibers with at least one of UV light, IR light, visible light, gamma radiation, and electro-beam radiation.

18. The method of claim 17, wherein the plurality of nanofibers includes a photoinitiator.

19. The method of claim 16, wherein the least one second MOF crystal material is formed in-situ using a process comprising reacting a mixture of ZrCl₄ and terephthalic acid in dimethylformamide in the presence of the cross-linked nanofibers.

20. The method of claim 16, wherein the at least one polymer precursor comprises poly(vinyl cinnamate).
